(19) United States
(12) Patent Application Publication
(10) Pub. No.: US 2025/0293871 A1
(43) Pub. Date: Sep. 18, 2025

(54) PRIVATE KEY RECOVERY DEVICE, PRIVATE KEY RECOVERY METHOD, AND STORAGE MEDIUM

(71) Applicant: NEC Corporation, Tokyo (JP)

(72) Inventors: Saki Otsuki, Tokyo (JP); Haruna FUKUDA, Tokyo (JP); Toshiyuki Isshiki, Tokyo (JP)

(73) Assignee: NEC Corporation, Tokyo (JP)

(21) Appl. No.: 19/013,075

(22) Filed: Jan. 8, 2025

(30) Foreign Application Priority Data
Mar. 15, 2024 (JP) 2024-041752

(51) Int. Cl. H04L 9/08

(52) U.S. Cl. CPC H04L 9/0866; H04L 9/0894

(57) ABSTRACT

A private key recovery device uses a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

### CROSS-REFERENCE TO RELATED APPLICATIONS

This application is based upon and claims the benefit of priority from Japanese patent application No. 2024-041752, filed on Mar. 15, 2024, the disclosure of which is incorporated herein in its entirety by reference.

### TECHNICAL FIELD

The present disclosure relates to a private key recovery device, a private key recovery method, and a storage medium.

### BACKGROUND ART

A private key is sometimes used in encryption, digital signatures, and the like. For example, Japanese Unexamined Patent Application, First Publication No. H11-088322 describes a technique where a digital signature is applied to message data using a user's private key only in a case where a feature amount of biometric signature data of a user requesting the digital signature matches a feature amount of biometric signature data that has been registered in advance.

### SUMMARY

It is preferable to be able to reduce the risk of leakage of the private key in a case where backing up a private key.

An example object of the present disclosure is to provide a private key recovery device, a private key recovery method, and a program that are capable of solving the problem described above.

According to a first example aspect of the present disclosure, a private key recovery device uses a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

According to a second example aspect of the present disclosure, a private key recovery method executed by a computer, the method uses a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

According to a third example aspect of the present disclosure, a non-transitory storage medium stores a program causing a computer to execute using a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

### BRIEF DESCRIPTION OF THE DRAWINGS

FIG. 1 is a diagram showing an example of a configuration of a private key backup system according to at least one example embodiment.

FIG. 2 is a diagram showing an example of a configuration of a key generation device according to at least one example embodiment.

FIG. 3 is a diagram showing an example of a configuration of a parameter generation device according to at least one example embodiment.

FIG. 4 is a diagram showing an example of a configuration of a parameter storage device according to at least one example embodiment.

FIG. 5 is a diagram showing an example of a configuration of a private key recovery device according to at least one example embodiment.

FIG. 6 is a diagram showing an example of a configuration of a private key storage device according to at least one example embodiment.

FIG. 7 is a diagram showing a processing procedure of the private key backup system 1 in a case where a parameter generation device according to at least one example embodiment generates a parameter.

FIG. 8 is a diagram showing a processing procedure of the private key backup system 1 in a case where a private key recovery device according to at least one example embodiment generates a private key x′.

FIG. 9 is a diagram showing an example of a configuration of a private key backup system according to at least one example embodiment.

FIG. 10 is a diagram showing an example of a configuration of a private key recovery device according to at least one example embodiment.

FIG. 11 is a diagram showing an example of a configuration of a private key recovery device according to at least one example embodiment.

FIG. 12 is a diagram showing an example of a processing procedure of a private key recovery method according to at least one example embodiment.

FIG. 13 is a diagram showing a configuration of a computer according to at least one example embodiment.

FIG. 14 is a diagram showing a configuration of a virtual machine according to at least one example embodiment.

### EXAMPLE EMBODIMENT

Hereunder, example embodiments of the present embodiment will be described. However, the following example embodiments do not limit the disclosure according to the claims. Furthermore, not all combinations of features described in the example embodiments are essential to the solution means of the disclosure.

### First Example Embodiment

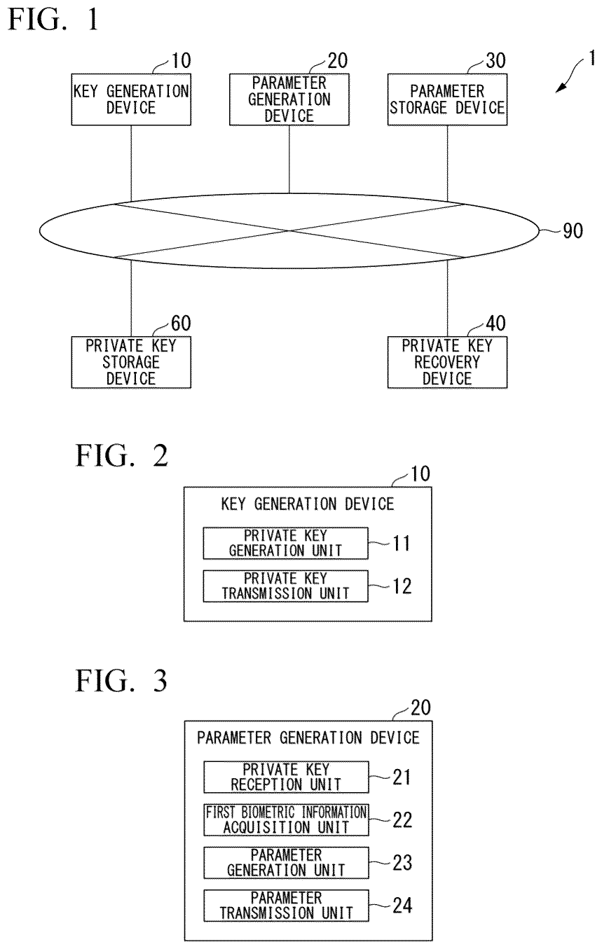

FIG. 1 is a diagram showing an example of a configuration of a private key backup system according to at least one example embodiment. In the configuration shown in FIG. 1, the private key backup system 1 includes a key generation device 10, a parameter generation device 20, a parameter storage device 30, a private key recovery device 40, and a private key storage device 60.

Furthermore, FIG. 1 shows a communication network 90. The communication network 90 may be configured as a portion of the private key backup system 1. Alternatively, the communication network 90 may be configured externally to the private key backup system 1.

The communication network 90 communicatively connects the key generation device 10, the parameter generation device 20, the parameter storage device 30, the private key recovery device 40, and the private key storage device 60. The communication network 90 is not limited to a specific type of network. For example, the communication network 90 may be configured using any one of a wired LAN (local area network), a wireless LAN, a WAN (wide area network), a mobile communication network, a virtual network, or a combination of these.

Furthermore, it is not necessary for all of the key generation device 10, the parameter generation device 20, the parameter storage device 30, the private key recovery device 40, and the private key storage device 60 to be able to communicate with all of the other devices. In particular, the key generation device 10 only needs to be able to communicate with the parameter generation device 20. The parameter generation device 20 only needs to be able to communicate with each of the key generation device 10 and the parameter storage device 30. The parameter storage device 30 only needs to be able to communicate with each of the parameter generation device 20 and the private key recovery device 40. The private key recovery device 40 only needs to be able to communicate with each of the parameter storage device 30 and the private key storage device 60. The private key storage device 60 only needs to be able to communicate with the private key recovery device 40.

The private key backup system 1 backs up a private key. In particular, the private key backup system 1 stores a parameter, which is data in which a private key and biometric information have been combined. In this respect, in the private key backup system 1, the risk of leakage of a private key is lower than a case where a private key is directly stored.

A private key is also denoted as a private key x.

The use of a private key that is backed up by the private key backup system 1 is not limited to a particular use. For example, the private key backup system 1 may back up a private key used for encryption, or back up a private key used for a digital signature.

The private key backup system 1 may combine a private key and the biometric information of an individual using the private key, such as the signer of a digital signature, or a sender of a ciphertext. Alternatively, if the usage permission of a private key is given to a representative, the private key backup system 1 may combine the private key and the biometric information of the representative.

The key generation device 10 generates a private key. The key generation device 10 may, for example, be configured using a computer.

The generation of the private key x by the key generation device 10 can be expressed as in expression (1).

$$x ← KeyGen ( {1}^{κ} ) \qquad ( 1 )$$

κ represents a security parameter. Here, the security parameter is a parameter that specifies the bit length of a key. The security parameter takes a positive integer value.

KeyGen represents an algorithm that generates a private key. KeyGen (1^{κ}) represents the generation of a κ-bit private key. Expression (1) represents the generation of a κ-bit private key x.

The algorithm KeyGen that the key generation device 10 uses to generate the private key x is not limited to a specific algorithm. For example, the key generation device 10 may generate the private key x using a known key generation algorithm.

The key generation device 10 may generate the private key x using a key algorithm other than an algorithm that directly receives a security parameter. For example, the key generation device 10 may use a setup algorithm to generate a common parameter from a security parameter. Then, the key generation device 10 may input the common parameter to the key generation algorithm to generate the private key x.

The common parameter referred to here is a parameter used to generate a private key. The common parameter includes, for example, information related to a group, and information related to a hash function. The common parameter is also referred to as a public parameter.

The processing that generates the common parameter is also referred to as setup. The key generation device 10 may generate the common parameter before starting the processing that generates the private key x.

The common parameter may be made known to the user. For example, the key generation device 10 may transmit the common parameter to the parameter generation device 20, the parameter storage device 30, the private key recovery device 40, and the private key storage device 60, or some of these devices, and share the common parameter.

The key generation device 10 transmits the private key x that has been generated to the parameter generation device 20.

The parameter generation device 20 generates a parameter s, which is data used to restore the private key x, based on the private key x and first biometric information w. The parameter generation device 20 may, for example, be configured using a computer.

The parameter s can also be thought of as a distributed private key. The parameter generation device is also referred to as a distributed private key generation device.

The first biometric information w is biometric information that is registered in advance (before the private key x is extracted) such that an unauthorized attempt to extract the private key x by a person who does not have an extraction permission of the private key x fails. The person corresponding to the first biometric information w (the subject from which the first biometric information was obtained) has an extraction permission of the private key x.

The biometric information used by the private key backup system 1 is not limited to a specific type of biometric information. For example, the private key backup system 1 may use biometric information obtained from feature data extracted from any one of a facial image, an iris image, a fingerprint image, voice data, or a combination of these, but it is not limited to this.

The parameter generation device 20 transmits the parameter s that has been generated, to the parameter storage device 30.

The parameter storage device 30 stores the parameter s. Specifically, the parameter storage device 30 stores the parameter s that has been received from the parameter generation device 20. Then, the parameter storage device 30 transmits the stored parameter s, to the private key recovery device 40. For example, the parameter storage device 30 may transmit the parameter s to the private key recovery device 40 according to a request from the private key recovery device 40.

The parameter storage device 30 may, for example, be configured using a computer.

The private key recovery device 40 recovers the private key x from the parameter s. More specifically, the private key recovery device 40 receives the parameter s from the parameter storage device 30. Furthermore, the private key recovery device 40 acquires second biometric information w′. Then, the private key recovery device 40 generates and outputs a private key x′ using the parameter s and the second biometric information w′. If the first biometric information w and the second biometric information w′ are similar to each other, then x′=x. Otherwise, x′≠x.

Because x′=x in a case where the first biometric information w and the second biometric information w′ are similar to each other, generation of the private key x′ by the private key recovery device 40 corresponds to recovery of the private key x.

The private key recovery device 40 may, for example, be configured using a computer.

The second biometric information w′ is used to authenticate an extraction permission holder of the private key x based on the relationship with the first biometric information w. In the private key backup system 1, authentication of an extraction permission holder of the private key x is performed such that an incorrect private key (data that is different to the private key x that has been generated by the key generation device 10) is extracted in a case where a person that does not have an extraction permission extracts the private key x.

Hereunder, extraction of an incorrect private key is also referred to as failing to extract the private key x. Furthermore, the private key x generated by the key generation device 10 is also referred to as the original private key x.

In order to prevent a person having an extraction permission of the private key x from failing to extract the private key x, the second biometric information w′ is preferably the same type of biometric information as the first biometric information w, and is biometric information that been collected in an environment as close as possible to the environment used to collect the first biometric information w. For example, it is preferable that the second biometric information w′ is collected using the same type of sensor as the sensor used to collect the first biometric information w.

In a case where the second biometric information w′ is at least as close to the first biometric information w as a predetermined condition, the private key x′ that is generated by the private key recovery device 40 is the same key as the original private key x.

More specifically, the private key recovery device 40 decodes data based on an encoded key ENC(x), in which the private key x has been encoded using an encoding scheme having linearity and an error correction capability, and a difference w−w′ between the first biometric information w and the second biometric information w′. The encoded key referred to here is the data obtained by encoding a key.

In a case where the difference w−w′ between the first biometric information w and the second biometric information w′ is within the range of the error correction capability of the encoding scheme, the difference w−w′ between the first biometric information w and the second biometric information w′ is cancelled out by the error correction at the time of decoding. As a result, the private key recovery device 40 obtains data that is based on the private key x and is not based on the biometric information.

Hereunder, an example will be described in which the private key recovery device 40 directly recovers the private key x in a case where the difference w−w′ between the first biometric information w and the second biometric information w′ is within the range of the error correction capability of the encoding scheme. Alternatively, the private key recovery device 40 may first obtain data from which the private key x can be recovered, and then recover the private key from the data.

On the other hand, in a case where the difference w−w′ between the first biometric information w and the second biometric information w′ is outside the range of the error correction capability of the encoding scheme, the difference w−w′ between the first biometric information w and the second biometric information w′ is not cancelled out. In this case, the private key recovery device 40 obtains data that is based on the private key x, and is also based on the biometric information.

In this case, the private key recovery device 40 fails to recover the private key x. That is to say, the private key x′ recovered by the private key recovery device 40 is different from the original private key x.

The private key recovery device 40 transmits the private key x′ that has been generated, to the private key storage device 60.

The private key storage device 60 stores the private key x′ from the private key recovery device 40. The private key storage device 60 may, for example, be configured using a computer. The private key storage device 60 may be configured as a function of a computer owned by a person who has an extraction permission of the private key x, such as a personal computer (PC) or smartphone of the person who has an extraction permission of the private key x.

In this way, because the private key recovery device 40 recovers the private key x from the parameter s, the private key backup system 1 does not need to directly store the private key x. According to the private key recovery device 40, in this respect, it is possible to reduce the risk of leakage of the private key in a case where backing up a private key.

Furthermore, the private key recovery device 40 outputs data that is different from the original private key x in a case where the difference between the first biometric information and the second biometric information is outside the error correction capability of the encoding scheme. As a result, in the private key recovery device 40, it is not possible for a person that does not have an extraction permission to extract the original private key x. According to the private key recovery device 40, in this respect, it is also possible to reduce the risk of leakage of the private key in a case where backing up a private key.

In addition, the person that uses the private key may manage the parameter s. In addition, the person that uses the private key may be capable of deleting the parameter that is stored in the parameter storage device 30.

In a case where the person that uses the private key wishes to invalidate the private key, such as in a case where a proxy permission of a representative that has been given an extraction permission of the private key is to be invalidated, the private key can be made to no longer be extracted from the private key backup system 1 as a result of deleting the parameter that is stored in the parameter storage device 30.

FIG. 2 is a diagram showing an example of a configuration of the key generation device 10. In the configuration shown in FIG. 2, the key generation device 10 includes a private key generation unit 11 and a private key transmission unit 12.

The private key generation unit 11 generates the private key x. The private key generation unit 11 corresponds to an example of a key generation means.

The private key generation unit 11 may generate the private key x by using an algorithm that directly receives a security parameter as in expression (1) above.

Alternatively, as described above with respect to the key generation device 10, the private key generation unit 11 may use a setup algorithm to generate a common parameter from a security parameter. Then, the private key generation unit 11 may input the common parameter to the key generation algorithm to generate the private key x.

For example, expression (2) represents the private key generation unit 11 using a setup algorithm to generate a common parameter from a security parameter.

$$pp ← Setup ( {1}^{κ} ) \qquad ( 2 )$$

Setup represents a setup algorithm.

pp represents a common parameter.

Expression (3) represents the private key generation unit 11 inputting the common parameter to a key generation algorithm to generate the private key x.

$$x ← KeyGen ( pp ) \qquad ( 3 )$$

In expression (3), KeyGen represents a key generation algorithm that receives the common parameter pp and generates a private key. The key generation algorithm KeyGen returns the private key x as a return value.

FIG. 3 is a diagram showing an example of a configuration of the parameter generation device 20. In the configuration shown in FIG. 3, the parameter generation device 20 includes a private key reception unit 21, a first biometric information acquisition unit 22, a parameter generation unit 23, and a parameter transmission unit 24.

The private key reception unit 21 receives the private key x from the key generation device 10.

The first biometric information acquisition unit 22 acquires the first biometric information w. For example, the first biometric information acquisition unit 22 may acquire biometric information of a subject that has been given an extraction permission of the private key x from a device storing biometric information, and use the biometric information as the first biometric information w. Alternatively, the first biometric information acquisition unit 22 may acquire data that becomes the basis of the biometric information, such as a fingerprint image captured by a camera, and then perform processing such as feature extraction from the acquired data to generate the biometric information, and use the obtained biometric information as the first biometric information w.

A subject that is given an extraction permission of the private key x is also referred to as an extraction permission holder.

The parameter generation unit 23 generates the parameter s based on the private key x and the first biometric information w. For example, the parameter generation unit 23 may generate the encoded key ENC(x) by encoding the private key x, and then generate the parameter s by combining the encoded key ENC(x) and the first biometric information w. In this case, the generation of the parameter s by the parameter generation unit 23 can be represented as in expression (4).

$$s ← ENC ( x ) + w \qquad ( 4 )$$

ENC represents encoding by an encoding scheme having linearity and an error correction capability.

The parameter generation unit 23 may perform the encoding using an error correcting coding such as a Hamming coding, a Bose-Chaudhuri-Hocquenghem (BCH) coding, a Reed-Solomon (RS) coding, or a low-density parity-check (LDPC) coding.

Alternatively, the parameter generation unit 23 may perform the encoding using an encoding scheme having an error correction capability, such as a lattice coding. For example, the parameter generation unit 23 may perform the encoding using a method that uses an integer lattice, a method that uses a triangular lattice, or a method that uses a more complicated lattice.

Hereunder, an example will be described in which the parameter generation unit 23 performs the encoding using an error correcting coding.

In expression (4), “+” represents taking a sum of the data. The sum of the data referred to here represents combination of data such that linearity can be obtained in the encoding scheme used by the private key backup system 1. Specifically, the private key backup system 1 uses encoding ENC and decoding DEC having the property shown in expression (5).

$$d 1 + d 2 = DEC ( ENC ( d 1 ) + ENC ( d 2 ) ) \qquad ( 5 )$$

d1 and d2 each represent data. Expression (5) indicates that, for arbitrary data d1 and d2, the data obtained by encoding each of the data d1 and d2, and then adding and decoding the data is equivalent to the data obtained by adding d1 and d2.

The “+” on the left side and the “+” on the right side of expression (5) may represent operations that are different from each other.

For example, each of the encoded key ENC(x) and the first biometric information w may be n-dimensional vectors, and the parameter generation unit 23 may perform vector addition to obtain the sum of the data. Here, n is an integer such that n≥1.

Here, with respect to the relationship between the encoding ENC and decoding DEC, processing that converts data d to data c by performing the encoding ENC can be represented as in expression (6).

$$c ← ENC ( d ) \qquad ( 6 )$$

In a case where the data c is converted by the decoding DEC, the original data d is obtained. This can be expressed as in expression (7).

$$d ← DEC ( c ) \qquad ( 7 )$$

Furthermore, even in a case where data c′, whose difference with the data c is within the range of the error correction capability of the encoding scheme, is converted by the decoding DEC, the same data d as in a case where the data c is converted by the decoding DEC is obtained. This can be expressed as in expression (8).

$$d ← DEC ( {c}^{′} ) \qquad ( 8 )$$

The parameter transmission unit 24 transmits the parameter s that has been generated by the parameter generation unit 23, to the parameter storage device 30.

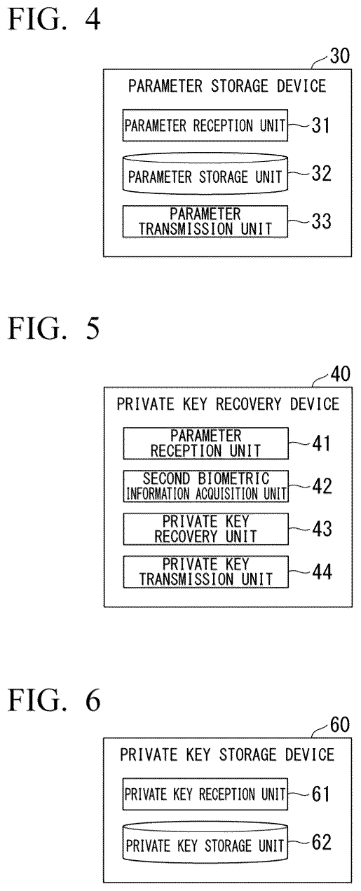

FIG. 4 is a diagram showing an example of a configuration of the parameter storage device 30. In the configuration shown in FIG. 4, the parameter storage device 30 includes a parameter reception unit 31, a parameter storage unit 32, and a parameter transmission unit 33.

The parameter reception unit 31 receives the parameter s from the parameter generation device 20. The parameter storage unit 32 stores the parameter s that has been received by the parameter reception unit 31. The parameter transmission unit 33 transmits the parameter s that is stored in the parameter storage unit 32, to the private key recovery device 40. For example, in a case where the private key recovery device 40 recovers the private key x, it may request the parameter storage device unit 30 to transmit the parameter s, and the parameter transmission unit 33 may transmit the parameter s in response to the request from the private key recovery device 40.

FIG. 5 is a diagram showing an example of a configuration of the private key recovery device 40. In the configuration shown in FIG. 5, the private key recovery device 40 includes a parameter reception unit 41, a second biometric information acquisition unit 42, a private key recovery unit 43, and a private key transmission unit 44.

The parameter reception unit 41 receives the parameter s from the parameter storage device 30. The parameter reception unit 41 corresponds to an example of a parameter acquisition means.

The second biometric information acquisition unit 42 acquires the second biometric information w′. The second biometric information w′ is biometric information of the person performing extraction of the private key x, and is expected to be biometric information of the same person as the first biometric information w, and the same type of biometric information as the first biometric information w.

The second biometric information acquisition unit 42 corresponds to an example of a second biometric information acquisition means.

The private key recovery device 40 may include a device that acquires data that becomes the basis of the biometric information, such as a camera that images a person's finger. Further, in a case where the private key recovery device 40 receives a request to recover the private key, the second biometric information acquisition unit 42 may acquire the data that becomes the basis of the biometric information, such as a fingerprint image captured by a camera. Alternatively, the second biometric information acquisition unit 42 may perform processing such as feature extraction from acquired data to generate the biometric information, and then use the obtained biometric information as the second biometric information w′.

As described above, in order to prevent a person having an extraction permission of the private key x from failing to extract the private key x, the second biometric information w′ is preferably the same type of biometric information as the first biometric information w, and is biometric information that has been collected in an environment as close as possible to the environment used to collect the first biometric information w. Therefore, it is preferable that the second biometric information acquisition unit 42 collects, as the second biometric information w′, the same type of biometric information as the first biometric information w that has been collected in an environment as close as possible to the environment used to collect the first biometric information w.

The private key recovery unit 43 generates the private key x′. As described above, in a case where the second biometric information w′ is at least as close to the first biometric information w as a predetermined condition, the private key x′ that is generated by the private key recovery device 40 is the same key as the original private key x. The private key recovery unit 43 corresponds to an example of a private key recovery means.

The private key recovery unit 43 recovers the private key x by decoding the difference obtained by subtracting the second biometric information w′ from the parameter s. The parameter s is data obtained by taking the sum of the encoded key ENC(x), which is the private key x after encoding, and the first biometric information w.

Alternatively, the parameter generation unit 23 may generate the parameter s in which the first biometric information w has been subtracted from the encoded key ENC(x). In this case, the private key recovery unit 43 may take the sum of the parameter s and the second biometric information w′.

In a case where the private key generated by the private key recovery unit 43 is represented by x′, the generation of the private key by the private key recovery unit 43 can be expressed as in expression (9).

$${x}^{′} ← DEC ( ENC ( x ) + ( w - {w}^{′} ) ) \qquad ( 9 )$$

Here, “−” represents the inverse operation to “+”.

In a case where the difference w−w′ between the first biometric information w and the second biometric information w′ is within the range of the error correction capability of the encoding scheme, the difference w−w′ between the first biometric information w and the second biometric information w′ is cancelled out by the decoding. In this case, as shown in expression (10), the private key x′ generated by the private key recovery unit 43 is the same as the original private key x.

$${x}^{′} = x \qquad ( 10 )$$

On the other hand, in a case where the difference w−w′ between the first biometric information w and the second biometric information w′ is outside the range of the error correction capability of the encoding scheme, DEC(w·w′) remains, which is the difference w−w′ between the first biometric information w and the second biometric information w′ after decoding. In this case, the private key x′ generated by the private key recovery unit 43 can be represented as in expression (11).

$${x}^{′} = x + DEC ( w - {w}^{′} ) \qquad ( 11 )$$

In this case, the private key x′ generated by the private key recovery unit 43 is different from the original private key x due to an effect that remains of the first biometric information w and the second biometric information w′.

The private key transmission unit 44 transmits the private key x′ that has been generated by the private key recovery unit 43, to the private key storage device 60.

In this way, as a method of utilizing the error correction capability of an error correcting coding, it is possible to apply a technique referred to as fuzzy commitment, which is a data protection scheme that combines an error correcting coding and an encryption technique, as described in, for example, Non-Patent Document: Juels, A. and Wattenberg, M., A Fuzzy Commitment Scheme, ACM CCS '99, 1999.

FIG. 6 is a diagram showing an example of a configuration of the private key storage device 60. In the configuration shown in FIG. 6, the key storage device 60 includes a private key reception unit 61 and a private key storage unit 62.

The private key reception unit 61 receives the private key x′ from the private key recovery device 40.

The private key storage unit 62 stores the private key x′ that has been received by the private key reception unit.

The private key storage device 60 may perform processing using the private key x′ that is stored in the private key storage unit 62. For example, the private key storage device 60 may have an encryption function, and perform encryption using the private key x′. The private key storage device 60 may have a digital signature function, and generate a signature using the private key x′.

Alternatively, the private key storage device 60 may transmit the private key x′ to another device according to a user operation.

The private key backup system 1 may perform the encoding ENC using an encoding function Encode, and perform the decoding DEC using a decoding function Decode. For example, the parameter generation unit 23 of the parameter generation device 20 may calculate the parameter s based on expression (12).

$$s ← Encode ( x ) + w \qquad ( 12 )$$

Furthermore, the private key recovery unit 43 of the private key recovery device 40 may generate the private key x′ based on expression (13).

$${x}^{′} ← Decode ( s - {w}^{′} ) \qquad ( 13 )$$

Alternatively, the private key backup system 1 may use the parameter s and the second biometric information w′ as arguments instead of the decoding function Decode, and calculate the private key x′ using a key difference recovery function (or a key difference recovery algorithm) Diff (DifRec) that recovers the difference between the key corresponding to the parameter s and the key corresponding to the second biometric information w′. For example, the private key recovery unit 43 of the private key recovery device 40 may generate the private key x′ based on expression (14).

$${x}^{′} ← Diff ( s , {w}^{′} ) \qquad ( 14 )$$

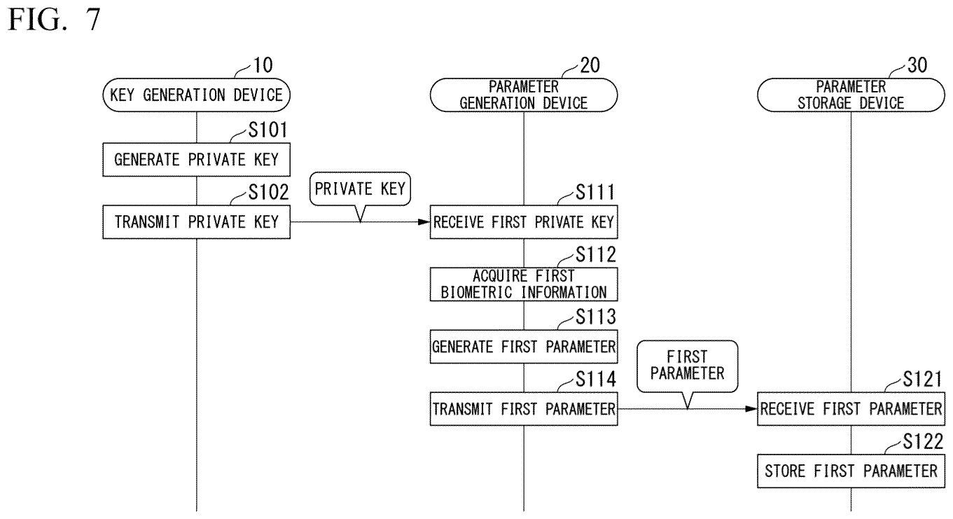

FIG. 7 is a diagram showing a processing procedure of the private key backup system 1 in a case where the parameter generation device 20 generates a parameter. The processing phase in which the parameter generation device 20 generates a parameter is also referred to as a parameter generation phase.

In the processing shown in FIG. 7, the private key generation unit 11 of the key generation device 10 generates the private key x (step S101).

Then, the private key transmission unit 12 transmits the private key x generated by the private key generation unit 11, to the parameter generation device 20 (step S102).

In the parameter generation device 20, the private key reception unit 21 receives the private key x that has been transmitted by the private key transmission unit 12 (step S111).

Furthermore, the first biometric information acquisition unit 22 acquires the first biometric information w (step S112). Then, the parameter generation unit 23 generates the parameter s based on the private key x and the first biometric information w (step S113).

In addition, the parameter transmission unit 24 transmits the parameter s generated by the parameter generation unit 23, to the parameter storage device 30 (step S114).

In the parameter storage device 30, the parameter reception unit 31 receives the parameter s that has been transmitted by the parameter transmission unit 24 (step S121).

Then, the parameter storage unit 32 stores the parameter received by the parameter reception unit 31 (step S122).

The parameter generation device 20 may perform the processing of step S111 and the processing of step S112 in any order. For example, the first biometric information acquisition unit 22 may acquire the first biometric information before the private key reception unit 21 receives the private key x.

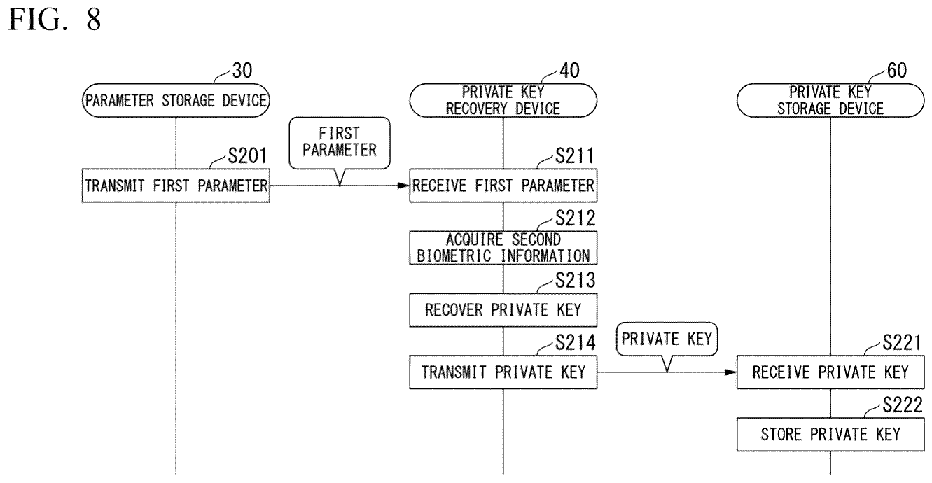

FIG. 8 is a diagram showing an example of a processing procedure of the private key backup system 1 in a case where the private key recovery device 40 generates the private key x′. The processing phase in which the private key recovery device 40 generates the private key x′ is also referred to as a private key recovery phase.

In the processing shown in FIG. 8, the parameter transmission unit 33 of the parameter storage device 30 transmits the parameter s that is stored in the parameter storage unit 32, to the private key recovery device 40 (step S201).

In the private key recovery device 40, the parameter reception unit 41 receives the parameter s that has been transmitted by the parameter transmission unit 33 (step S211).

Furthermore, the second biometric information acquisition unit 42 acquires the second biometric information w′ (step S212).

Then, the private key recovery unit 43 generates the private key x′ using the parameter s and the second biometric information w′ (step S213).

Further, the private key transmission unit 44 transmits the private key x′ that has been generated by the private key recovery unit 43, to the private key storage device 60 (step S214).

In the private key storage device 60, the private key reception unit 61 receives the private key that has been transmitted by the private key transmission unit 44 (step S221).

Then, the private key storage unit 62 stores the private key that has been received by the private key reception unit 61 (step S222).

Although an example of a case where an error correcting coding having linearity is used as the error correcting coding has been described above, it is not limited to this.

As described above, the private key recovery unit 43 uses a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

According to the private key recovery device 40, because the private key x is recovered from the parameter s, the private key backup system 1 does not need to directly store the private key x. According to the private key recovery device 40, in this respect, it is possible to reduce the risk of leakage of the private key in a case where backing up a private key.

Furthermore, the private key recovery device 40 outputs data that is different from the original private key x in a case where the difference between the first biometric information and the second biometric information is outside the error correction capability of the encoding scheme. As a result, in the private key recovery device 40, it is not possible for a person that does not have an extraction permission to extract the original private key x. According to the private key recovery device 40, in this respect, it is also possible to reduce the risk of leakage of the private key in a case where backing up a private key. In particular, according to the private key recovery device 40, the risk of key recovery by a person that does not have permission can be reduced.

In a case where the difference between the first biometric information and the second biometric information is within the range of the error correction capability of the encoding scheme, the first biometric information and the second biometric information are cancelled out by the decoding. As a result, the private key recovery unit 43 can be considered to decode the private key and acquire data that was affected by the biometric information, and it is expected that private key can be recovered using the data.

Because the private key recovery device 40 recovers the private key, it is not necessary to directly store the private key as a backup of a private key. According to the private key recovery device 40, in this respect, it is possible to reduce the risk of leakage of the private key in a case where backing up a private key. Specifically, according to the private key recovery device 40, even in a case where a leakage of backup information (information held by the private key recovery device 40) occurs, the private key is not acquired by a person that does not have permission.

Furthermore, the private key recovery device 40 outputs data that is different from the original private key x in a case where the difference between the first biometric information and the second biometric information is outside the error correction capability of the encoding scheme. As a result, in the private key recovery device 40, it is not possible for a person that does not have an extraction permission to extract the original private key x. According to the private key recovery device 40, in this respect, it is also possible to reduce the risk of leakage of the private key in a case where backing up a private key.

In addition, the parameter reception unit 41 acquires the parameter s.

The second biometric information acquisition unit 42 acquires the second biometric information.

The private key recovery unit 43 generates data decoded by the encoding scheme using the difference obtained by subtracting the second biometric information from the parameter.

According to the private key recovery device 40, the private key can be recovered by the relatively simple processing of taking the difference between data, and performing decoding. According to the private key recovery device 40, in this respect, it is expected that the processing load of recovery of the private key will be relatively low.

### Second Example Embodiment

The parameter storage device 30 and the private key recovery device 40 may be integrally configured, and the private key recovery device 40 may store the parameter s. In addition, the person using the private key may be capable of deleting the parameter s that is stored in the private key recovery device 40. This aspect will be described in the second example embodiment.

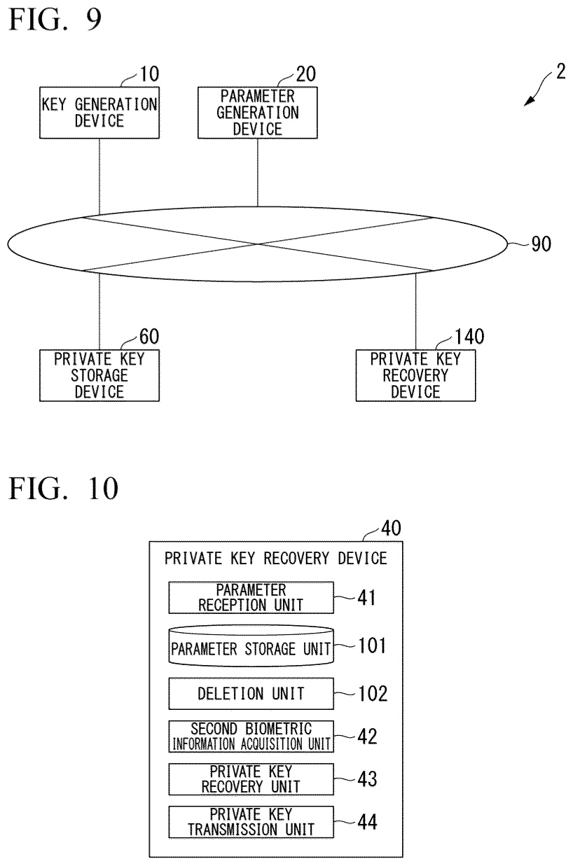

FIG. 9 is a diagram showing an example of a configuration of a private key backup system according to at least one example embodiment. In the configuration shown in FIG. 9, the private key backup system 2 includes a key generation device 10, a parameter generation device 20, a private key recovery device 140, and a private key storage device 60.

Furthermore, FIG. 9 shows a communication network 90.

Of the units in FIG. 9, those units having the same functions as the units shown in FIG. 1 are designated by the same reference symbols (10, 20, 60 and 90), and a detailed description will be omitted here.

The private key backup system 2 differs from the private key backup system 1 in that it does not include a parameter storage device 30. Furthermore, in the private key backup system 2, the configuration of the private key recovery device 140 is different from the configuration of the private key recovery device 40 of the private key backup system 1.

The private key backup system 2 is the same as the private key backup system 1 in all other respects.

In the private key backup system 2, the parameter generation device 20 transmits the parameter s that has been generated, to the private key recovery device 140.

FIG. 10 is a diagram showing an example of a configuration of the private key recovery device 140.

In the configuration shown in FIG. 10, the private key recovery device 140 includes a parameter reception unit 41, a parameter storage unit 101, a deletion unit 102, a second biometric information acquisition unit 42, a private key recovery unit 43, and a private key transmission unit 44.

Of the units in FIG. 10, those units having the same functions as the units shown in FIG. 5 are designated by the same reference symbols (41, 42, 43 and 44), and a detailed description will be omitted here.

The private key recovery device 140 differs from the private key recovery device 40 in that it includes the parameter storage unit 101 and the deletion unit 102. The private key recovery device 140 is the same as the private key recovery device 40 in all other respects.

In the private key recovery device 140, the private key recovery unit 43 recovers the private key using the parameter s that is stored in the parameter storage unit 101.

The parameter storage unit 101 stores the parameters that has been received by the parameter reception unit 41. The parameter storage unit 101 corresponds to an example of a parameter storage means.

The deletion unit 102 deletes the parameter s that is stored in the parameter storage unit 101 in a case where a user operation is received that instructs the parameter s to be deleted. The deletion unit 102 corresponds to an example of a deletion means.

In a case where the person that uses the private key wishes to invalidate the private key, such as in a case where a proxy permission of a representative that has been given an extraction permission of the private key is to be invalidated, it is possible to cause the deletion unit 102 to delete the parameter s that is stored in the parameter storage unit 101. As a result of deleting the parameter that is stored in the parameter storage device 30, the private key can be made to no longer be extracted from the private key backup system 1.

As described above, the parameter storage unit 101 stores the parameter.

The deletion unit 102 deletes the parameter that is stored in the parameter storage means according to a user instruction.

The private key recovery unit 43 generates a second private key using the parameter that is stored in the parameter storage means.

In the private key recovery device 140, in a case where the person that uses the private key wishes to invalidate the private key, such as in a case where a proxy permission of a representative that has been given an extraction permission of the private key is to be invalidated, it is possible to cause the deletion unit 102 to delete the parameter s that is stored in the parameter storage unit 101. As a result of deleting the parameter that is stored in the parameter storage device 30, the private key can be made to no longer be extracted from the private key backup system 1.

### Third Example Embodiment

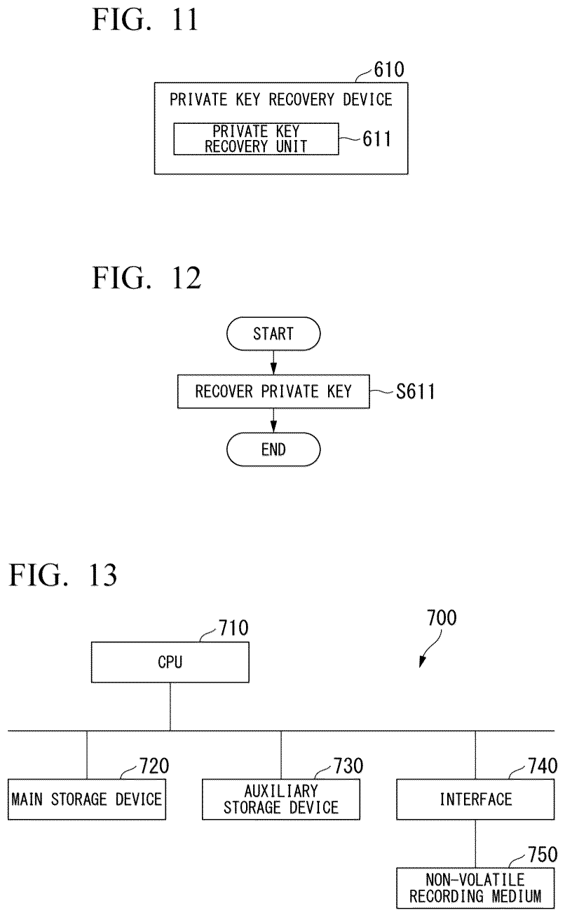

FIG. 11 is a diagram showing an example of a configuration of a private key recovery device according to at least one example embodiment. In the configuration shown in FIG. 11, the private key recovery device 610 includes a private key recovery unit 611.

In such a configuration, the private key recovery unit 611 uses a parameter, being data obtained by taking a sum of first biometric information and an encoded key obtained by encoding a private key using an encoding method having an error correction capability, and second biometric information, to generate data in which data based on the encoded key and a difference obtained by subtracting the second biometric information from the first biometric information is decoded.

The private key recovery unit 611 corresponds to an example of a private key recovery means.

According to the private key recovery device 610, because the private key is recovered from the parameter, it is not necessary for the private key x to be directly stored for backup of the private key. According to the private key recovery device 610, in this respect, it is possible to reduce the risk of leakage of the private key in a case where backing up a private key.

Furthermore, the private key recovery device 610 outputs data that is different from the original private key in a case where the difference between the first biometric information and the second biometric information is outside the error correction capability of the encoding scheme. As a result, in the private key recovery device 610, it is not possible for a person that does not have an extraction permission to extract the original private key. According to the private key recovery device 610, in this respect, it is also possible to reduce the risk of leakage of the private key in a case where backing up a private key.

### Fourth Example Embodiment

FIG. 12 is a diagram showing an example of a processing procedure of a private key recovery method according to at least one example embodiment. The private key recovery method shown in FIG. 12 includes a step for recovering a private key (step S611).

In the step for recovering a private key (step S611), a computer performs the step of using a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

According to the private key recovery method shown in FIG. 12, because the private key is recovered from the parameter, it is not necessary for the private key x to be directly stored for backup of the private key. According to the private key recovery device 610, in this respect, it is possible to reduce the risk of leakage of the private key in a case where backing up a private key.

Furthermore, according to the private key recovery method shown in FIG. 12, data that is different from the original private key x is output in a case where the difference between the first biometric information and the second biometric information is outside the error correction capability of the encoding scheme. As a result, with the private key recovery method shown in FIG. 12, it is not possible for a person that does not have an extraction permission to extract the original private key. According to the private key recovery method shown in FIG. 12, in this respect, it is also possible to reduce the risk of leakage of the private key in a case where backing up a private key.

FIG. 13 is a diagram showing a configuration of a computer according to at least one example embodiment. In the configuration shown in FIG. 13, a computer 700 includes a CPU 710, a main storage device 720, an auxiliary storage device 730, an interface 740, and a non-volatile recording medium 750.

Any one or more of the key generation device 10, the parameter generation device 20, the parameter storage device 30, the private key recovery device 40, the private key storage device 60, the private key recovery device 140, the private key recovery device 610, or a portion thereof, may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Further, the CPU 710 secures a storage area corresponding to each of the storage units in the main storage device 720 according to the program. The communication of each device with other devices is executed as a result of the interface 740 having a communication function and performing communication according to the control of the CPU 710. Furthermore, the interface 740 includes a port for the non-volatile recording medium 750, and reads information from the non-volatile recording medium 750 and writes information to the non-volatile recording medium 750.

In a case where the key generation device 10 is implemented by the computer 700, the operation of the private key generation unit 11 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the key generation device 10 to perform processing according to the program. The communication between the key generation device 10 and other devices, such as the operation of the private key transmission unit 12, is executed as a result of the interface 740 including a communication function and operating under the control of the CPU 710. The interactions between the key generation device 10 and the user is executed as a result of the interface 740 having an input device and an output device, presenting information to the user through the output device under the control of the CPU 710, and accepting user operations through the input device.

In a case where the parameter generation device 20 is implemented by the computer 700, the operation of the parameter generation unit 23 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the parameter generation device 20 to perform processing according to the program. The communication between the parameter generation device 20 and other devices, such as the operation of the private key reception unit 21 and the parameter transmission unit 24, is executed as a result of the interface 740 including a communication function and operating under the control of the CPU 710. The interactions between the parameter generation device 20 and the user is executed as a result of the interface 740 having an input device and an output device, presenting information to the user through the output device under the control of the CPU 710, and accepting user operations through the input device. The acquisition of biometric information by the first biometric information acquisition unit 22 is executed as a result of the interface 740 including a sensor and operating under the control of the CPU 710.

In a case where the parameter storage device 30 is implemented by the computer 700, the operation of the parameter storage device 30 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the parameter storage device 30, such as the parameter storage unit 32, to perform processing according to the program. The communication between the parameter storage device 30 and other devices, such as the operation of the parameter reception unit 31 and the parameter transmission unit 33, is executed as a result of the interface 740 including a communication function and operating under the control of the CPU 710. The interactions between the parameter storage device 30 and the user is executed as a result of the interface 740 having an input device and an output device, presenting information to the user through the output device under the control of the CPU 710, and accepting user operations through the input device.

In a case where the private key recovery device 40 is implemented by the computer 700, the operation of the private key recovery unit 43 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the private key recovery device 40 to perform processing according to the program. The communication between the private key recovery device 40 and other devices, such as the operation of the parameter reception unit 41 and the private key transmission unit 44, is executed as a result of the interface 740 including a communication function and operating under the control of the CPU 710. The interactions between the private key recovery device 40 and the user is executed as a result of the interface 740 having an input device and an output device, presenting information to the user through the output device under the control of the CPU 710, and accepting user operations through the input device. The acquisition of biometric information by the second biometric information acquisition unit 42 may be executed as a result of the interface 740 including a sensor and operating under the control of the CPU 710.

In a case where the private key storage device 60 is implemented by the computer 700, the operation of the private key storage device 60 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the private key storage device 60, such as the private key storage unit 62, to perform processing according to the program. The communication between the private key storage device 60 and other devices, such as the operation of the private key reception unit 61, is executed as a result of the interface 740 including a communication function and operating under the control of the CPU 710. The interactions between the private key storage device 60 and the user is executed as a result of the interface 740 having an input device and an output device, presenting information to the user through the output device under the control of the CPU 710, and accepting user operations through the input device.

In a case where the private key recovery device 140 is implemented by the computer 700, the operation of the deletion unit 102 and the private key recovery unit 43 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the private key recovery device 140, such as the parameter storage unit 101, to perform processing according to the program. The communication between the private key recovery device 140 and other devices, such as the operation of the parameter reception unit 41 and the private key transmission unit 44, is executed as a result of the interface 740 including a communication function and operating under the control of the CPU 710. The interactions between the private key recovery device 140 and the user is executed as a result of the interface 740 having an input device and an output device, presenting information to the user through the output device under the control of the CPU 710, and accepting user operations through the input device. The acquisition of biometric information by the second biometric information acquisition unit 42 may be executed as a result of the interface 740 including a sensor and operating under the control of the CPU 710.

In a case where the private key recovery device 610 is implemented by the computer 700, the operation of the private key recovery unit 611 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area in the main storage device 720 for the private key recovery device 610 to perform processing according to the program. The communication between the private key recovery device 610 and other devices is executed as a result of the interface 740 including a communication function and operating under the control of the CPU 710. The interactions between the private key recovery device 610 and the user is executed as a result of the interface 740 having an input device and an output device, presenting information to the user through the output device under the control of the CPU 710, and accepting user operations through the input device.

One or more of the programs described above may be recorded in the non-volatile recording medium 750. In this case, the interface 740 may read out the program from the non-volatile recording medium 750. Then, the CPU 710 directly executes the program that has been read out by the interface 740, or executes the program after temporarily saving it in the main storage device 720 or the auxiliary storage device 730.

The main storage device 720, the auxiliary storage device 730, and the non-volatile recording medium 750 may each include one or more of a semiconductor storage such as a RAM (random access memory), a ROM (read only memory), or an EEPROM (electrically erasable and programmable ROM), a HDD (hard disk drive), a CD (compact disc), a DVD (digital versatile disc), and the like.

The interface 740 may include an input/output device and a communication interface. The input/output device may have a configuration including a keyboard and a display.

Furthermore, in the parameter generation device 20, the private key recovery device 40, and the private key recovery device 140 that acquire biometric information, the interface 740 may be configured to include a sensor for acquiring the biometric information. In this case, the sensor may be an image sensor (camera) if the biometric information is a face, an iris, or the like, or a fingerprint sensor if the biometric information is a fingerprint. Further, in a case where the biometric information is a finger vein, for example, the sensor may be a LED (light emitting diode) that irradiates near-infrared light, and a near-infrared camera that images the light passing through the finger.

The sensor may be a removable sensor, such as a universal serial bus (USB) device. The interface 740 may include a network interface card, a transceiver, and the like, and may be configured to communicate with each other via a LAN (local area network), a WAN (wide area network) such as the Internet, a wireless LAN, a mobile communication network, and the like.

Furthermore, in the parameter generation device 20, the private key recovery device 40, and the private key recovery device 140, the interface 740 may be configured to include an interface that communicatively connects to an external sensor (for example, a sensor with short-range communication connectivity), and receive biometric information acquired by the external sensor.

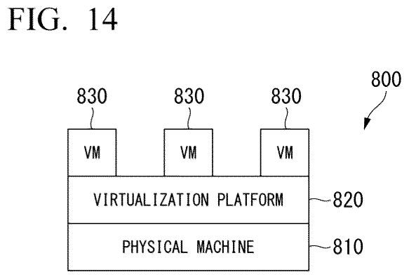

FIG. 14 is a diagram showing a configuration of a virtual machine according to at least one example embodiment. In the example of FIG. 14, in the virtualization server 800, a virtualization platform 820 such as a hypervisor is provided on a physical machine 810, and virtual machines 830 are provided thereon.

Any one or more of the key generation device 10, the parameter generation device 20, the parameter storage device 30, the private key recovery device 40, the private key storage device 60, the private key recovery device 140, the private key recovery device 610, or a portion thereof, may be implemented by the virtual machine 830. The virtualization server 800 provides a virtual server environment in which a plurality of servers operate, although it is physically a single server. Each virtual machine 830 is preferably set to operate in an isolated environment in the memory space.

In this case, in the virtual machine 830, a program that realizes the processing of any one of the key generation device 10, the parameter generation device 20, the parameter storage device 30, the private key recovery device 40, the private key storage device 60, the private key recovery device 140, and the private key recovery device 610 operates on the virtual OS (operating system) of the virtual machine.

The virtual machine 830 that virtually implements any one of the key generation device 10, the parameter generation device 20, the parameter storage device 30, the private key recovery device 40, the private key storage device 60, the private key recovery device 140, and the private key recovery device 610 may have a configuration that communicatively connects with another virtual machine via a virtual network, or may have a configuration that communicatively connects with any one of the other devices among the key generation device 10, the parameter generation device 20, the parameter storage device 30, the private key recovery device 40, the private key storage device 60, the private key recovery device 140, and the private key recovery device 610, via a LAN, the Internet, or the like, through a physical interface (communication interface) of the physical machine 810.

A program for executing some or all of the processing performed by the key generation device 10, the parameter generation device 20, the parameter storage device 30, the private key recovery device 40, the private key storage device 60, the private key recovery device 140, and the private key recovery device 610 may be recorded in a computer-readable recording medium, and the processing of each unit may be performed by a computer system reading and executing the program recorded on the recording medium. The “computer system” referred to here is assumed to include an OS (operating system) and hardware such as a peripheral device.

Furthermore, the “computer-readable recording medium” refers to a portable medium such as a flexible disk, a magnetic optical disk, a ROM (read only memory), or a CD-ROM (compact disc read only memory), or a storage device such as a hard disk built into a computer system. Moreover, the program may be one capable of realizing some of the functions described above. Further, the functions described above may be realized in combination with a program already recorded in the computer system.

As described above, the encoding scheme used in the present disclosure is not limited to a specific method. For example, encoding using a square lattice, or error correcting coding such as an RS coding and a BCH coding may be used. Furthermore, the biometric information is not limited to a real number vector, and may be an integer vector.

Example embodiments of the present disclosure have been described in detail above with reference to the drawings. However, specific configurations are in no way limited to the example embodiments, and include designs and the like within a scope not departing from the spirit of the present disclosure. In addition, the example embodiments described above may be combined as appropriate with other example embodiments.

According to an example aspect of the present disclosure, it is possible to reduce the risk of leakage of the private key when backing up a private key.

While preferred example embodiments of the disclosure have been described and illustrated above, it should be understood that these are example embodiments of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

The whole or part of the example embodiments above can be described as the supplementary notes below, but the example embodiments are not limited thereto.

### (Supplementary Note 1)

A private key recovery device comprising:

a private key recovery means that uses a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

### (Supplementary Note 2)

The private key recovery device according to supplementary note 1, comprising
a parameter acquisition means that acquires the parameter, and
a second biometric information acquisition means that acquires the second biometric information, wherein
the private key recovery means generates data in which a difference obtained by subtracting the second biometric information from the parameter is decoded using the encoding scheme.

### (Supplementary Note 3)

The private key recovery device according to supplementary note 2, comprising
a parameter storage means that stores the parameter, and
a deletion means that deletes the parameter stored in the parameter storage means according to an instruction from a user, wherein
the private key recovery means generates the data using the parameter stored in the parameter storage means.

### (Supplementary Note 4)

A private key recovery method that causes a computer to perform the step of:

using a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

### (Supplementary Note 5)

The private key recovery method according to supplementary note 4 that causes the computer to perform the steps of:
acquiring a parameter; and
acquiring the second biometric information; wherein
recovering the private key includes the computer performing the step of generating data in which a difference obtained by subtracting the second biometric information from the parameter is decoded using the encoding scheme.

### (Supplementary Note 6)

The private key recovery method according to supplementary note 5 that causes the computer to perform the step of:
deleting the stored parameter according to a user instruction; wherein
recovering the private key includes the computer performing the step of generating the data using the parameter that is stored in the parameter storage means.

### (Supplementary Note 7)

A program that causes a computer to execute the step of:

using a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

### (Supplementary Note 8)

The program according to supplementary note 7 that causes the computer to execute the steps of:
acquiring a parameter; and
acquiring the second biometric information; wherein
recovering the private key causes the computer to execute the step of generating data in which a difference obtained by subtracting the second biometric information from the parameter is decoded using the encoding scheme.

### (Supplementary Note 9)

The program according to supplementary note 8 that causes the computer to execute the step of:
deleting the stored parameter according to a user instruction; wherein
recovering the private key causes the computer to execute the step of generating the data using the parameter that is stored in the parameter storage means.

What is claimed is:

1. A private key recovery device comprising:
at least one memory configured to store instructions; and
at least one processor configured to execute the instructions to:
use a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

2. The private key recovery device according to claim 1, wherein the at least one processor is configured to execute the instructions to:
acquire the parameter;
acquire the second biometric information; and
generate data in which a difference obtained by subtracting the second biometric information from the parameter is decoded using the encoding scheme.

3. The private key recovery device according to claim 2, wherein the at least one processor is configured to execute the instructions to:
store the parameter;
delete the stored parameter according to an instruction from a user; and
generate the data using the stored parameter.

4. A private key recovery method executed by a computer, the method comprising:
using a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

5. The private key recovery method according to claim 4, further comprising:
acquiring the parameter;
acquiring the second biometric information; and
generating data in which a difference obtained by subtracting the second biometric information from the parameter is decoded using the encoding scheme.

6. The private key recovery method according to claim 5, further comprising:
storing parameter;
deleting the stored parameter according to an instruction from a user; and
generating the data using the stored parameter.

7. A non-transitory storage medium storing a program that causes a computer to execute:
using a parameter, being data obtained by taking a sum of first biometric information and an encoded key obtained by encoding a private key using an encoding scheme having an error correction capability, and second biometric information, to generate data in which data based on the encoded key and a difference obtained by subtracting the second biometric information from the first biometric information is decoded using the encoding scheme.

8. The non-transitory storage medium according to claim 7, wherein the program causes the computer to execute:
acquiring the parameter;
acquiring the second biometric information; and
generating data in which a difference obtained by subtracting the second biometric information from the parameter is decoded using the encoding scheme.

9. The non-transitory storage medium according to claim 8, wherein the program causes the computer to execute:
storing parameter;
deleting the stored parameter according to an instruction from a user; and
generating the data using the stored parameter.
